(19) United States
(12) Patent Application Publication
(10) Pub. No.: US 2026/0154754 A1
(43) Pub. Date: Jun. 4, 2026

(54) Micro-Resource-Pooling System And Corresponding Method Thereof

(71) Applicant: Swiss Reinsurance Company Ltd., Zurich (CH)

(72) Inventors: Nikhil DA VICTORIA LOBO, New York, NY (US); Simon YOUNG, Zurich (CH)

(21) Appl. No.: 19/461,674

(22) Filed: Jan. 27, 2026

Related U.S. Application Data
(62) Division of application No. 13/920,906, filed on Jun. 18, 2013.
Application No. 13/920,906 is a continuation of application No. PCT/EP2012/061661, filed on Jun. 19, 2012.

(51) Int. Cl. G06Q 40/08; G06Q 10/0635

(52) U.S. Cl. CPC G06Q 40/08; G06Q 10/0635

(57) ABSTRACT

The invention relates to a resource-pooling system and to a corresponding method for risk sharing of a variable number of risk exposure components. The risk exposure components are connected to the resource-pooling system by means of a plurality of payment receiving modules configured to receive and store payments from risk exposure components for the pooling of their risks. The total risk of the pooled risk exposure components comprises a first risk contribution associated to risk exposure in relation to loan losses, and a second risk contribution associated to risk exposure based on emergency expenses. The pooled risk is divided in a parameterizable risk part and a non-parameterizable risk part by means of an indexing module. In case of triggering a loss by means of a trigger module, the suffered loss is covered by releasing associated loans and emergency expenses of the risk exposure components.

### LIST OF REFERENCES

1 Resource-pooling system
   11 Parameterizable risk part
   12 Non-parameterizable risk part
   101 Monetary parameter transfer to the resource-pooling system 1 initiated by a payment receiving module 2
   102 Monetary parameter transfer based on a loss settlement payment by means of the resource-pooling system 1 to the payment receiving modules 2 or directly to the pooled risk exposure components 21, 22, 23 . . .
2 Payment receiving modules
   21, 22, 23 . . . . Pooled risk exposure components
   211 First risk contribution
   212 Second risk contribution
   2001 Transferring payments
   2002 Embedded loan
3 Connected loss coverage system
   301 Premium and/or claim payment parameters
   302 Risk factors and/or premium payment
4 Invest access units
   41 Payment or capital receiving module
   42 Payment or capital deposit module

### CROSS-REFERENCE TO RELATED APPLICATIONS

This application is a divisional of and claims benefit under 35 U.S.C. § 120 to U.S. application Ser. No. 13/920,906, filed Jun. 18, 2013, which is a continuation of International Patent Application No. PCT/EP12/61661, filed Jun. 19, 2012, the entire contents of each of which are incorporated by reference in their entirety.

### FIELD OF THE INVENTION

The present invention relates to a resource-pooling system and corresponding method for risk sharing of a variable number of risk exposure components by providing a self-sufficient risk protection for the risk exposure components by means of the resource-pooling system. Especially, the invention is directed to automated micro entrepreneurs units receiving micro-insurance based damage coverage, which proceeds e.g. after devastating catastrophe. Such risk-pooling systems comprise typically at least an assembly module to process risk related data of the components and to provide the likelihood of said risk exposure for one or a plurality of the pooled risk exposure components based on the risk related data of the components. The pooling system can be underlaid or supplemented by a donor-capitalized complement unit.

### BACKGROUND OF THE INVENTION

One of the most challenging aspects in the risk transfer technology is capturing and balancing risk exposure of small units associated with an instable financial background. Especially in the poor regions of our world, there is a massive gap between economic and insured losses due to the lack of appropriate means in the risk transfer and damage covering industry. FIG. 3 shows the natural catastrophe losses from the years 1980 to 2010 in USD billion worldwide. FIG. 3 demonstrates that the effective economic loss is far from being covered by the insured loss. These is one of the reasons why natural catastrophes not only pose a material risk to society but also give rise to political instabilities and pressing welfare risks. Since this misbalance is far more severe in poor regions as typically found in developing countries, the present invention is directed to the problems associated to risk transfer in such regions.

Providing the technical features to enable risk covering for people and societies at the bottom of the pyramid is a key element in development and research in that field. It is characteristic for the problem that the poor face more risks in their life than the well-off situated, and more important, they are more vulnerable to the devastation that can be caused by the loss of life, health or an asset. In literature, it is often pointed out that poverty and risk transfer as e.g. insurance facilities do not fit together, and insurance is totally beyond the affordability of the poor. In developing countries like many states of the African, Asian or central Asian continent or even in newly industrialized countries as e.g. India, this statement would hold, for sure to a certain extent.

Providing the technical means for the systematic management of financial risks associated to the livelihoods and lives of the rural and/or urban poor based on their characteristic possibilities through adapted means can be one of the ways out of the dilemma. However, the characteristics of the poor give difficult basis for risk transfer, since they have typically no or a very small financial background. Further they are difficult to be captured by a system due to the environmental conditions in which they are embedded in, and due to their large number. In the state of the art, mechanism, as e.g. micro-insurance systems, try to offer new ways of combating the problem. Micro-insurance based systems can provide greater economic and psychological security to the poor since it reduces exposure to multiple risks and lessons the impact of a disaster. In the state of the art, the technical means for micro-insurance systems are often provided in conjunction with micro savings means and micro credit means in order to become a working system and to keep the captured units or people away from the poverty trap representing in these systems typically an integral component of financial inclusion. Somehow, the addressed units in the poor regions need a conviction that paying for risk transfer respectively buying insurance coverage is more worthwhile to them than being without it. For sure, different factors and boundary conditions have to be considered by reducing the vulnerability of the poor including the role of the specific Government subsidizing micro-insurance systems and Regulators ensuring proper development of both social and/or rural sector. However, as long as there is no real working system, these factors are constrained from contributing to the solution.

While micro-risk transfer systems, as e.g. micro-insurance systems, can act as a buffer against risks faced by the poor, it is vulnerable to such systems to consider the conditions in which these systems operate. The operational and financial stability of these micro-insurance systems are at stake given the high risk clientele they cater to, and the limited funds at the disposal of the system. Unlike other consumer specific systems, risk transfer systems have peculiar traits that prove challenging when applying the system to the target population. While some risks may pose threats to the survival of a micro-insurance system, others may undermine the operation of the system and/or limit its ability to meet the set objectives. It is therefore essential for such systems to identify and implement appropriate and effective risk management features, and more broadly adopt the necessary technical approach. The presence of an operating risk management structure can enhance the system credibility. Lowered risk leads to improved operations and increased sustainability, which allows the systems to be seen as low risk, and therefore a better investment for partners and clients supporting the system. Associated reinsuring systems will also be more forthcoming in dealing with risk-managed insurance systems. Donors, potential staff, supporters, and clients also benefit from incorporation such technical structures as the improved financial standing works in their favor.

### Technical Objects of the Invention

It is an object of this invention to provide automated operable system and the technical means and method thereof for a resource-pooling system (i.e. an “aggregation” institute) for risk sharing of a variable number of risk exposure components by providing a self-sufficient risk protection for the risk exposure components by means of the operation of the resource-pooling system. It is a further object of the present invention to provide such a resource-pooling system and an appropriately implemented method for the systematic and automated or at least half automated management of financial risks associated to the livelihoods and lives of the rural and/or urban poor based on their characteristic conditions through specific adapted features. The system should provide a stable operation to threats to the survival of the system, as well as to threats undermining the operation of the system and/or limit its ability to meet the set objectives. It should be capable of implementing appropriate and effective risk management features, and broadly adopt the necessary technical approach. It is yet a further object of the present invention to provide a system, which enhances through its stable operating risk management structure the system's credibility and lowered risk by improved operations and increased sustainability, which allows the systems to be operated at low risk, and therefore allow the system to give basis to better investment grounds for partners and clients supporting the system. Finally the system should provide a more forthcoming environment and technical underlying operation to associated reinsuring systems cooperating with the technical means of the risk-managed insurance systems.

### SUMMARY OF THE INVENTION

According to the present invention, these objects are achieved particularly through the features of the independent claims. In addition, further advantageous embodiments follow from the dependent claims and the description.

According to the present invention, the above-mentioned objects are particularly achieved in that the resource-pooling system for risk sharing of a variable number of risk exposure components by providing a self-sufficient risk protection for the risk exposure components by means of the resource-pooling system comprises at least an assembly module to process risk related components data and to provide the likelihood of said risk exposure for one or a plurality of the pooled risk exposure components based on the risk related components data, in that the risk exposure components are connected to the resource-pooling system by means of a plurality of payment receiving modules configured to receive and store payments from risk exposure components for the pooling of their risks, in that the total risk of the pooled risk exposure components comprises a first risk contribution associated to risk exposure in relation to loan losses, wherein the loan losses occur as consequence to insolvency of risk exposure components owing to the occurrence of a risk event contributable to the risk exposure, in that the total risk of the pooled risk exposure components comprises a second risk contribution associated to risk exposure based on emergency expenses, wherein the emergency expenses occur for risk exposure components owing to the occurrence of a risk event contributable to the risk exposure, in that by means of an indexing module the pooled risk is divided in a parameterizable risk part and a non-parameterizable risk part, wherein the parameterizable risk part is transferred to a connected loss coverage system by means of a multidirectional risk transfer module transferring risk factors in exchange of premium payment parameters to achieve loss covering of the parameterizable risk part by means of the connected loss coverage system, in that the non-parameterizable risk part is directly covered by the resource-pooling system based on the received and stored payments from risk exposure components, and that in case of triggering a loss by means of a trigger module suffered loss is covered by releasing associated loans and emergency expenses of the risk exposure components by transferring payments from the resource-pooling system to the risk exposure components based on the parameterizable risk part from the connected loss coverage system and based on the non-parameterizable risk part from the received and stored payments from risk exposure components. In the event of basis risk, the risk of mismatch between actual losses incurred from a given loss event versus 10 the payout received for the same loss event from an index-based or parametric insurance and/or event-driven product, the resource-pooling system will automatically or semi-automatically access its capital base to absorb some of this risk. Remaining basis risk will be limited through a novel loss settlement process that aligns all parties with the goal of long term economic development. The parameter for the alignment can be set in advance or ad-hoc. In a special embodiment variant, the parameter setting for the novel loss settlement process is achieved by means of the system using pattern matching of Monte Carlo simulated or historical long term development patterns. The basis risk coverage is aimed at meeting any gaps between what the parameterizable risk part covers for a particular risk exposure component or client for a given event and what the given risk exposure component or client is required to monetarily transfer under its defined risk exposure parameters, i.e. its own written commitments. In this way, the separation of the parameterizable and non-parameterizable parts preferably are kept connected through a “seamless integration” both in financial exposure an process, i.e. the end or final “risk exposure components” are not affected by differences in the transfer or the risk. The system acts as a aggregation institute to aggregate the risk and provide claims to the risk exposure components in a seamless process so that the risk exposure components receive a single payment. Further, the risk transfer from the risk exposure components to the risk-pooling system by means of the multidimensional risk transfer module scales to the magnitude of the exposure, so in that the risk transfer module is rather multidirectional or scaled than binomial. This allows for payments under the parametizable component that is more attuned to real losses. The invention has, inter alia, the advantage that the system and method permit for the first time the automation of the capturing and monitoring of a stable operatable resource-pooling system for risks associated to the livelihoods and lives of the rural and/or urban poor based on their characteristic conditions through specific adapted features. At the same time, the invention results in a substantial advantage with regard to provide such a resource-pooling system for the systematic and automated management of financial risks associated to lives of the poor. In contrast to the realization of the present system, it was scarcely possible to provide a stable operation to threats to the survival of the system, as well as to threats undermining the operation of the system and/or limit its ability to meet the set objectives with the systems and methods of the prior art. The system of the present invention is capable of implementing appropriate and effective risk management features, and broadly adopts the necessary technical approach.

In a preferred embodiment, the variable numbers of pooled risk exposure components are adaptable by the resource-pooling system to a range where not-covariant occurring risks covered by the resource-pooling system affect only a relatively small proportion of the totally pooled risk exposure components at a given time. This variant has, inter alia, the advantage that the operational and financial stability of the system can be improved.

In a further embodiment, the system comprises a payment receiving module configured to receive and store a principal payment from an investor for a financial product linked to the resource-pooling system and a payment module configured to determine a bonus payment for the investor and a return interest payment for the investor when the pooled resources of the risk exposure components exceed a predefined threshold value due to a low frequency of losses occurred. This variant has, inter alia, the advantage that the interaction between the invest access units can be eased.

In another embodiment, the parameterizable risk part of the risk exposure covers a relatively large percentage of the total risk exposure of the pooled risk exposure components in relation to the non-parameterizable risk part. This variant has, inter alia, the advantage that the operational and financial stability of the system can be improved.

In an alternative embodiment, the parameterizable risk part covers a range of 70% to 95% of the total pooled risk, while the non-parameterizable risk part covers a range of 30% to 5% of the total pooled risk. This variant has, inter alia, the same advantages as the preceeding embodiment variant.

### BRIEF DESCRIPTION OF THE DRAWINGS

The present invention will be explained in more detail, by way of example, with reference to the drawings in which:

FIG. 1 shows a block diagram illustrating schematically an exemplary configuration of the underlying technical structure for the risk transfer of a system according to the present invention. The reference numeral 1 refers to a resource-pooling system connected e.g. over a network to the components with the reference numeral 2, 3, 41/42 and/or 21, 22, 23, . . .

FIG. 2 shows a flow diagram illustrating an example of a rough overview of the concept of the risk transfer according to the invention.

FIG. 3 shows a diagram illustrating the natural catastrophe losses in the years 1980 to 2010, in USD billion by economic loss (grand total) and insured loss (grand total). It illustrates the massive gap between economic and insured losses and in that way the need for a technically proper and stable operable systems for risk transfer, especially for the poorer regions of the world.

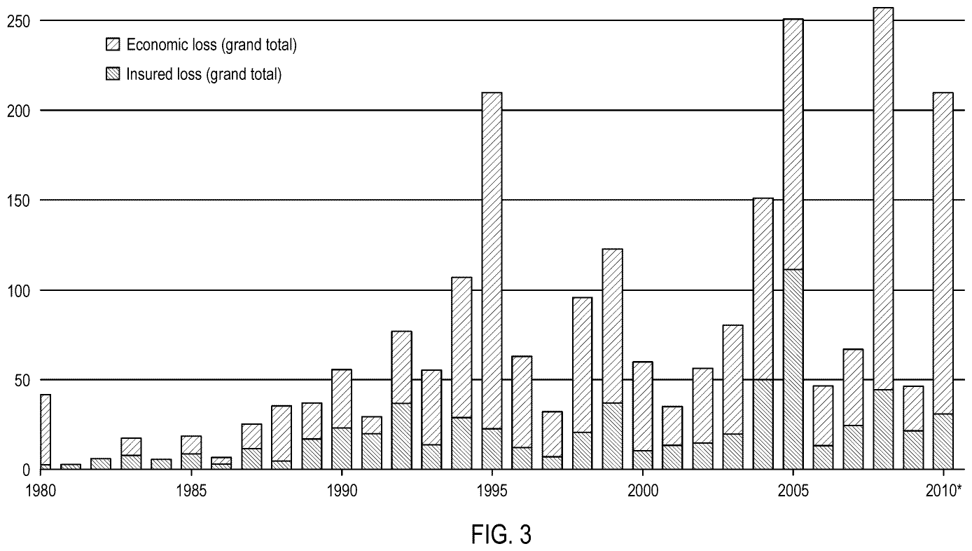

### DETAILED DESCRIPTION OF THE PREFERRED EMBODIMENTS

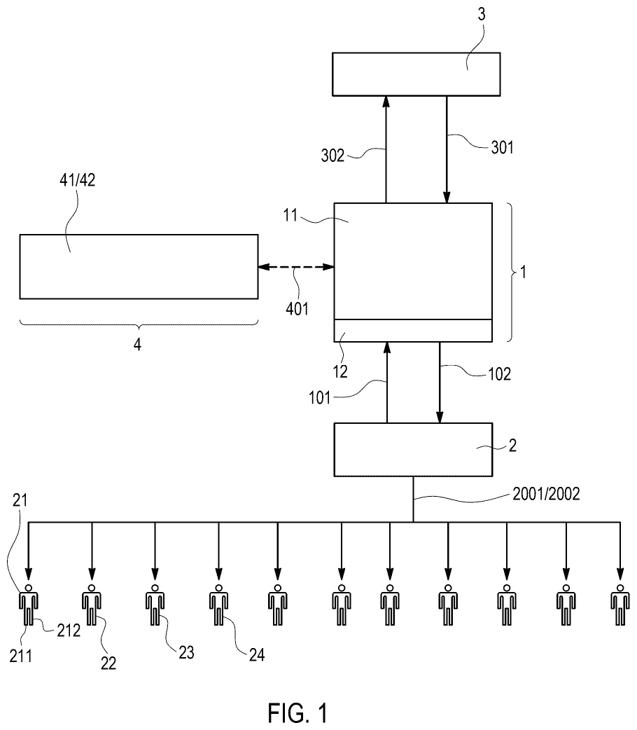

In FIG. 1, reference numeral 1 refers to a resource-pooling system for risk sharing of a variable number of risk exposure components 21, 22, 23 . . . by providing a self-sufficient risk protection for the risk exposure components 21, 22, 23 . . . by means of the resource-pooling system 1. The system 1 includes at least one processor and associated memory modules. The system 1 can also include one or more display units and operating elements such as a keyboard, and/or graphical pointing devices as a computer mouse. The risk-pooling system 1 comprises at least an assembly module to process risk related components data and to provide the likelihood of said risk exposure for one or a plurality of the pooled risk exposure components 21, 22, 23 . . . based on the risk related components data. The resource-pooling system 1 can be realized as a technical platform developed and implemented to provide micro-insurance through a plurality of (but at least one) payment receiving modules 2 which can be realized as a part of e.g. microfinance institutions (MFIs). However, it is important to note that within this document the payment receiving modules 2 not only refer to systems related to microfinance institutions (MFIs) but can be realized as a part of any aggregation institute or aggregator, such as e.g. farming cooperatives or the like. The risk associated to the pooled resources can e.g. comprise covering rainfall, flood, hurricane and earthquake risk, but also other risks, including health and agriculture etc.,

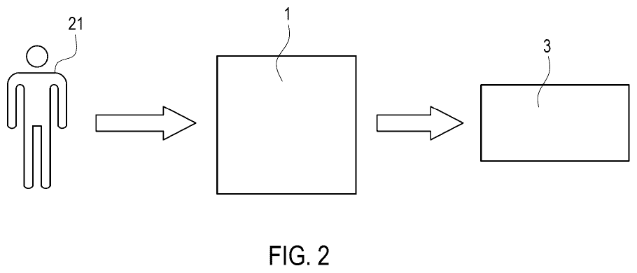

FIG. 2 illustrated the concept and problems of the micro-insurance technology. The reference numeral 21, as pooled risk exposure components, can e.g. be represented by an insured or policyholder in insurance terms. However, the reference numerals 21, 22, 23 . . . are associated risk exposure component, which are connected to the system over a network. The technical structure of the resource pooling system is generally directed to risk transfer and associated pooling of resources and not restricted by the terms of insurance technology. To make such catastrophe micro-insurance systems operable in the field of very poor countries, the system 1 must be able to provide protection, which is easy to understand, portable and allow for quick settlement. Further, in order to stabilize the system 1, e.g. by transferring the resource-pooling system 1 risk efficiently to international markets e.g. by means of a plurality of invest access units 4 and/or by means of the at least one connected loss covering systems 3, coverage must be easy to price, not subject to manipulation, and allow for quick settlement.

As illustrated schematically in FIG. 1, in addition, the system 1 includes a data storing module to capture the risk related components' data and multiple functional modules, e.g. namely the payment receiving modules 2, the connected loss coverage system 3, the payment receiving module or capital receiving module 41 and/or the payment module or capital deposit module 42. The functional modules can be implemented at least partly as programmed software modules stored on a computer readable medium, connected fixed or removable to the processor(s) of system 1 or to associated automated systems as e.g. systems 3. One skilled in the art understands, however, that the functional modules can also be implemented fully by means of hardware components, units and/or appropriately realized modules. As illustrated in FIG. 1, system 1 is connected via a network as a telecommunications network to the payment receiving modules 2, the connected loss coverage system 3, the payment receiving module 41 and/or the payment module 42. The network can include a wired or wireless network, e.g. the Internet, a GSM-network (Global System for Mobile Communication), an UMTS-network (Universal Mobile Telecommunications System) and/or a WLAN (Wireless Local Region Network), and/or dedicated point-to-point communication lines. The invest access units 4 comprise a payment receiving module 41 and/or the payment module 42 to transfer monetary parameters. The monetary parameters can be secured or unsecured. In any case, the technical electronic money schemes for the present system comprises adequate technical, organizational and procedural safeguard means to prevent, contain and detect threats to the security of the scheme, particularly the threat of counterfeits.

The resource-pooling system 1 comprises further all necessary technical means for electronic money transfer and association e.g. initiated by one or more associated invest access units 4 over an electronic network. The monetary parameters can be based on all possible electronic and transferable means as e.g. e-currency, e-money, electronic cash, electronic currency, digital money, digital cash, digital currency, or cyber currency etc., which can only be exchanged electronically. Preferably for the present invention, this involves the use of the mentioned network as e.g. computer networks or telecommunication networks, and/or the worldwide internet and digital stored value systems. Electronic funds transfer (EFT), direct deposit, digital gold currency and virtual currency are further examples of electronic money. Also, the transfer can involve technology as financial cryptography and technologies enabling it. For the transaction of monetary parameters preferable hard electronic currency is used not having the technical possibilities to dispute or reverse charges. Typically, the system 1 only supports non-reversible transactions. The advantage of this arrangement is that the operating costs of the electronic currency system are greatly reduced by not having to resolve payment disputes. Additionally, it allows the electronic currency transactions to clear instantly, making the funds available immediately to the system 1. This means that using hard electronic currency is more akin to a cash transaction. However, it is also imaginable to use soft electronic currency as one that allows for reversal of payments, for example having a “clearing time” of 72 hours or the like. The way of electronic monetary parameter exchange applies to all connected systems and modules to the resource-pooling system 1 of the present invention as e.g. the payment receiving modules 2, the invest access units 4 with the payment receiving modules 41 and the payment modules 42 or the connected loss coverage systems 3. The reference numeral 301 shows the parametric payment transfer to the resource-pooling system 1 in case of triggered loss. The reference numeral 302 shows the parametric monetary transfer e.g. in form of a premium transferred to the connected loss coverage system 3, e.g. represented by a reinsurance unit. Reference numeral 302 in FIG. 1 also refers to the premium payment, i.e. the associated monetary transfer. The reference numeral 101 shows the monetary parameter transfer to the resource-pooling system 1 initiated by a payment receiving module 2 e.g. representing a micro-insurance premiums transferred to the resource-pooling system 1. The reference numeral 102 shows the monetary parameter transfer based on a loss settlement payment by means of the resource-pooling system 1 to the payment receiving modules 2 or directly to the pooled risk exposure components 21, 22, 23 . . .

The risk exposure components 21, 22, 23 . . . are connected to the resource-pooling system 1 by means of a plurality of payment receiving modules 2 configured to receive and store payments from risk exposure components 21, 22, 23 . . . for the pooling of their risks. The total risk of the pooled risk exposure components 21, 22, 23 . . . comprises a first risk contribution 211 associated to risk exposure in relation to loan losses, wherein the loan losses occur as consequence to insolvency of risk exposure components 21, 22, 23 . . . owing to the occurrence of a risk event contributable to the risk exposure. I.e. the payment receiving modules 2, which can be realized as MFI, embeds risk transfer e.g. in form of a insurance within a given loan.

The total risk of the pooled risk exposure components 21, 22, 23 . . . comprises a second risk contribution 212 associated to risk exposure based on emergency expenses, wherein the emergency expenses occur for risk exposure components 21, 22, 23 . . . owing to the occurrence of a risk event contributable to the risk exposure. By means of an indexing module the pooled risk is divided in a parameterizable risk part 11 and a non-parameterizable risk part 21. The parameterizable risk part 11 is transferred to a connected loss coverage system 3 by means of a multidirectional risk transfer module transferring risk factors 302 in exchange of premium payment parameters 301 to achieve loss covering of the parameterizable risk part 11 by means of the connected loss coverage system 3. Reference numeral 301 in FIG. 1 also refers to claim payment parameters. The separation of the parameterizable and non-parameterizable parts preferably are kept connected through a “seamless integration” both in financial exposure an process, i.e. the end or final “risk exposure components” are not affected by differences in the transfer or the risk. Further, the risk transfer preferably is not only binomial, but scales to the magnitude of the exposure, so in that sense the risk transfer module is described as multidirectional or scaled. The connected loss covering system 3 can be realized as an automated and integrated part of an associated reinsurance system.

The resource-pooling system 1 can e.g. use index-based policies to provide risk transfer support e.g. reinsurance means at a cost-efficient basis. Payment transfer can be made e.g. in as little as two-weeks preferably by transmitting electronic payment parameters, but can be also realized by other electronic means. In the way of the present realization, the resource-pooling system 1 is capable to absorb small claims and leverages at a single administration, which reduces expenses. The whole technical structure of the present invention is built to provide the most cost efficient way of resource pooling associated to risks of the connected units, which is not possible in this way by the state of the art systems. To reduce further the operational expenses, the payment receiving modules 2 as a part of said microfinance institutions can be used as the distribution network for the insurance policies according to the invention. The MFIs collect premiums, make payments and handle basic administration. As embodiment variant, in order to align interests, the MFIs 2 can be conditioned to transfer capital, e.g. in form of financial secured parameters, in the resource-pooling system 1 before being associated to the resource-pooling system 1 respectively participating at the system.

The non-parameterizable risk part 12 is directly covered by the resource-pooling system 1 based on the received and stored payments from risk exposure components. The parameterizable risk part 11 of the risk exposure can cover a relatively large percentage of the total risk exposure of the pooled risk exposure components in relation to the non-parameterizable risk part 12, and/or the parameterizable risk part 11 can cover a range of 70% to 95% of the total pooled risk, while the non-parameterizable risk part (12) covers a range of 30% to 5% of the total pooled risk. In case of triggering a loss by means of a trigger module suffered loss is covered by releasing associated loans and emergency expenses of the risk exposure components 21, 22, 23 . . . by transferring payments 2001 from the resource-pooling system 1 to the risk exposure components 21, 22, 23 . . . based on the parameterizable risk part 11 from the connected loss coverage system 3 and based on the non-parameterizable risk part 12 from the received and stored payments from risk exposure components 21, 22, 23 . . .

In operation, the system according to the invention can be associated to microfinance institutions in a country. The resource-pooling system 1 can make coverage available to a restricted amount of pooled risk exposure components 21, 22, 23 . . . as e.g. 50,000 or to an open number of pooled components. The system allows the pooled risk exposure components 21, 22, 23 . . . to pay for coverage at the outset of each new loan. Once damage to the home and/or business assets for each pooled risk exposure components 21, 22, 23 . . . has been established, the payment receiving modules 2 will eliminate the value of that pooled risk exposure components 21, 22, 23 . . . debt and pay a fixed sum for the rebuilding process. A new loan will also be made available as soon as each pooled risk exposure component 21, 22, 23 . . . is ready.

In an embodiment variant, the variable number of pooled risk exposure components 21, 22, 23 . . . can be adaptable by the resource-pooling system 1 to a range where not-covariant occurring risks covered by the resource-pooling system 1 affect only a relatively small proportion of the totally pooled risk exposure components 21, 22, 23 . . . at a given time. Further, the system can comprise a payment receiving module 41 configured to receive and store a principal payment from an investor for a financial product linked to the resource-pooling system 1 and a payment module 42 configured to determine a bonus payment for the investor and a return interest payment for the investor when the pooled resources of the risk exposure components 21, 22, 23 . . . exceed a predefined threshold value due to a low frequency of losses occurred.

1. A processor-based, micro-component aggregation system for automated management of micro components exposed to impacts of an occurring natural catastrophes comprising occurring flood or hurricane or earthquake or agriculture catastrophes, the processor-based, micro-component aggregation system comprising:
a processor programmed to
capture, monitor, and process components data and provide an impact exposure as a likelihood for an impact to a large number of components based on the components data, the impact exposure being associated with livelihoods and lives of rural or urban people based on their characteristic conditions through specific adapted features, wherein
a total impact exposure of the large number of components includes a first contribution associated to exposure data in relation to loan losses, the loan losses occurring as consequence to possible insolvency of at least some of the components owing to the occurrence of a natural catastrophe contributable to the impact exposure, and
the total impact exposure of the components includes a second contribution associated to impact exposure based on emergency expenses, the emergency expenses occurring for components owing to the occurrence of a natural catastrophe contributable to the impact exposure,
separate the total impact exposure into a parametrizable binomial risk contribution and a non-parametrizable contribution, the parametrizable contribution being parametrizable by applying a binomial parametrization,
achieve loss covering of the parametrizable contribution via a connected loss coverage system by transfer of the parametrizable contribution, the transfer being scaled to a magnitude of the total impact exposure of the components by scaling a percentage of the transferred exposure of the components in a range of 70% to 95% of the total exposure, in relation to the non-parametrizable contribution covering a range of 30% to 5% of the total exposure, thereby adapting an operation of the processor-based, micro-component aggregation system to meet said characteristic conditions of livelihoods and lives of the rural and/or urban poor until a stable operation is achieved, and
cover the non-parametrizable risk contribution directly by the processor-based, micro-component aggregation system, the non-parametrizable risk contribution being limited by ad-hoc setting of loss parameters of a loss covering process via the processor-based, micro-component aggregation system by aligning the parameters to historical long term development patterns of the covering process using pattern by matching of historical long term development patterns, and keeping by the loss covering process the parametrized, binomial contributions and the non-parametirized, pattern-recognized contributions connected by seamless integration during the loss covering process.

2. The system according to claim 1, wherein in an event of triggering a loss by a trigger module, the suffered loss is covered by automatically releasing associated loans and emergency expenses associated with the components by the processor-based, micro-component aggregation system.

3. The system according to claim 1, wherein the large number of components are adaptable by the processor-based, micro-component aggregation system to a range where not-covariant occurring risks covered by the resource-pooling system affect only a relatively small proportion of the totally pooled risk exposure components at a given time.

4. The system according to claim 1, wherein the parametrizable part of the impact exposure covers a relatively large percentage of the total exposure of the large number of components in relation to the non-parametrizable part.

5. The system according to claim 1, wherein the parametrizable part covers a range of 70% to 95% of a total pooled risk, while the non-parametrizable part covers a range of 30% to 5% of the total exposure.

6. The system according to claim 1, wherein the separation of the parametrizable and non-parametrizable parts are kept connected through a seamless integration both in financial exposure and process, wherein the system acts as an aggregation engine to aggregate risk and provide claims to the components in a seamless process so that the components receive an automatic single payment transfer.

7. The system according to claim 1, wherein exposure transferred from the components to the system via a multidimensional transfer module is not only binomial but multidirectional by scaling to the magnitude of the exposure.

8. A method for a processor-based, micro-component aggregation system for automated management of micro components exposed to impacts of an occurring natural catastrophes comprising occurring flood or hurricane or earthquake or agriculture catastrophes, the method comprising:
capturing, monitoring, and processing components data and providing an impact exposure as a likelihood for an impact to a large number of components based on the components data, the impact exposure being associated with livelihoods and lives of rural or urban people based on their characteristic conditions through specific adapted features, wherein
a total impact exposure of the large number of components includes a first contribution associated to exposure data in relation to loan losses, the loan losses occurring as consequence to possible insolvency of at least some of the components owing to the occurrence of a natural catastrophe contributable to the impact exposure, and
the total impact exposure of the components includes a second contribution associated to impact exposure based on emergency expenses, the emergency expenses occurring for components owing to the occurrence of a natural catastrophe contributable to the impact exposure;
separating the total impact exposure into a parametrizable binomial risk contribution and a non-parametrizable contribution, the parametrizable contribution being parametrizable by applying a binomial parametrization;
achieving loss covering of the parametrizable contribution via a connected loss coverage system by transfer of the parametrizable contribution, the transfer being scaled to a magnitude of the total impact exposure of the components by scaling a percentage of the transferred exposure of the components in a range of 70% to 95% of the total exposure, in relation to the non-parametrizable contribution covering a range of 30% to 5% of the total exposure, thereby adapting an operation of the processor-based, micro-component aggregation system to meet said characteristic conditions of livelihoods and lives of the rural and/or urban poor until a stable operation is achieved; and
covering the non-parametrizable risk contribution directly by the processor-based, micro-component aggregation system, the non-parametrizable risk contribution being limited by ad-hoc setting of loss parameters of a loss covering process via the processor-based, micro-component aggregation system by aligning the parameters to historical long term development patterns of the covering process using pattern by matching of historical long term development patterns, and keeping by the loss covering process the parametrized, binomial contributions and the non-parametrized, pattern-recognized contributions connected by seamless integration during the loss covering process.

9. The method according to claim 8, wherein in an event of triggering a loss by a trigger module, the suffered loss is covered by automatically releasing associated loans and emergency expenses associated with the components by the processor-based, micro-component aggregation system.

10. The method according to claim 8, wherein the large number of components are adaptable by the processor-based, micro-component aggregation system to a range where not-covariant occurring risks covered by the resource-pooling system affect only a relatively small proportion of the totally pooled risk exposure components at a given time.

11. The method according to claim 8, wherein the parametrizable part of the impact exposure covers a relatively large percentage of the total exposure of the large number of components in relation to the non-parametrizable part.

12. The method according to claim 8, wherein the parametrizable part covers a range of 70% to 95% of a total pooled risk, while the non-parametrizable part covers a range of 30% to 5% of the total exposure.

13. The method according to claim 8, wherein the separation of the parametrizable and non-parametrizable parts are kept connected through a seamless integration both in financial exposure and process, wherein the system acts as an aggregation engine to aggregate risk and provide claims to the components in a seamless process so that the components receive an automatic single payment transfer.

14. The method according to claim 8, wherein exposure transferred from the components to the system via a multidimensional transfer module is not only binomial but multidirectional by scaling to the magnitude of the exposure.

15. A non-transitory computer-readable medium storing computer-readable instructions thereon which when executed by a processor-based, micro-component aggregation system for automated management of micro components exposed to impacts of an occurring natural catastrophes comprising occurring flood or hurricane or earthquake or agriculture catastrophes, causes the processor-based, micro-component aggregation system to perform a method, the method comprising:
capturing, monitoring, and processing components data and providing an impact exposure as a likelihood for an impact to a large number of components based on the components data, the impact exposure being associated with livelihoods and lives of rural or urban people based on their characteristic conditions through specific adapted features, wherein
a total impact exposure of the large number of components includes a first contribution associated to exposure data in relation to loan losses, the loan losses occurring as consequence to possible insolvency of at least some of the components owing to the occurrence of a natural catastrophe contributable to the impact exposure, and
the total impact exposure of the components includes a second contribution associated to impact exposure based on emergency expenses, the emergency expenses occurring for components owing to the occurrence of a natural catastrophe contributable to the impact exposure;
separating the total impact exposure into a parametrizable binomial risk contribution and a non-parametrizable contribution, the parametrizable contribution being parametrizable by applying a binomial parametrization;
achieving loss covering of the parametrizable contribution via a connected loss coverage system by transfer of the parametrizable contribution, the transfer being scaled to a magnitude of the total impact exposure of the components by scaling a percentage of the transferred exposure of the components in a range of 70% to 95% of the total exposure, in relation to the non-parametrizable contribution covering a range of 30% to 5% of the total exposure, thereby adapting an operation of the processor-based, micro-component aggregation system to meet said characteristic conditions of livelihoods and lives of the rural and/or urban poor until a stable operation is achieved; and
covering the non-parametrizable risk contribution directly by the processor-based, micro-component aggregation system, the non-parametrizable risk contribution being limited by ad-hoc setting of loss parameters of a loss covering process via the processor-based, micro-component aggregation system by aligning the parameters to historical long term development patterns of the covering process using pattern by matching of historical long term development patterns, and keeping by the loss covering process the parametrized, binomial contributions and the non-parametrized, pattern-recognized contributions connected by seamless integration during the loss covering process.

16. The non-transitory computer-readable medium according to claim 15, wherein in an event of triggering a loss by a trigger module, the suffered loss is covered by automatically releasing associated loans and emergency expenses associated with the components by the processor-based, micro-component aggregation system.

17. The non-transitory computer-readable medium according to claim 15, wherein the large number of components are adaptable by the processor-based, micro-component aggregation system to a range where not-covariant occurring risks covered by the resource-pooling system affect only a relatively small proportion of the totally pooled risk exposure components at a given time.

18. The non-transitory computer-readable medium according to claim 15, wherein the parametrizable part of the impact exposure covers a relatively large percentage of the total exposure of the large number of components in relation to the non-parametrizable part.

19. The non-transitory computer-readable medium according to claim 15, wherein the parametrizable part covers a range of 70% to 95% of a total pooled risk, while the non-parametrizable part covers a range of 30% to 5% of the total exposure.

20. The non-transitory computer-readable medium according to claim 15, wherein the separation of the parametrizable and non-parametrizable parts are kept connected through a seamless integration both in financial exposure and process, wherein the system acts as an aggregation engine to aggregate risk and provide claims to the components in a seamless process so that the components receive an automatic single payment transfer.
